(19) United States
(12) Patent Application Publication
(10) Pub. No.: US 2021/0291755 A1
(43) Pub. Date: Sep. 23, 2021

(54) INTERCHANGEABLE DOOR LINER SYSTEM

(71) Applicant: Cheryl Cawley, Kenbridge, VA (US)

(72) Inventor: Cheryl Cawley, Kenbridge, VA (US)

(21) Appl. No.: 16/824,727

(22) Filed: Mar. 20, 2020

(51) Int. Cl. B60R 13/02; B60J 5/04

(52) U.S. Cl. CPC B60R 13/0243; B60J 5/0413; B60J 5/0468

(57) ABSTRACT

An interchangeable door liner system including at least one panel cover member and a strip member. The at least one panel cover member is configured to attached to an interior door panel of an automobile. The at least one panel cover member has a plurality of primary fastener members integrated therein positioned along an outline of the at least one panel cover member. The strip member is integrated into the interior door panel and forms a frame surrounding an area of the interior door panel where the at least one panel cover member is attached. The strip member has a plurality of secondary fasteners integrated therein positioned along the strip member in a same position as a corresponding primary fastener member integrated in the at least one panel cover member. Each secondary fastener member and corresponding primary fastener member is configured to attach to one another in a mating connection thereby providing a semi-permanent attachment of the at least one panel cover member to the interior door panel.

### FIELD OF THE INVENTION

Embodiments described herein generally relate to automobile accessories, and more particularly to automobile door accessories.

### BACKGROUND OF THE INVENTION

Currently within the market of auto accessories, there are vast options for décor but they often require permanent fixtures and/or a large monetary investment to establish uniqueness.

and thus becomes lost. Other times, the left package/parcel may be damaged due to bad weather conditions. When the mail or packages are lost, stolen or damaged, the delivery service or retailer has to replace the them, which costs the company/seller a huge sum of money. Hence, an improved way to deliver mail and packages is desirable.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of an interchangeable door liner system according to an embodiment of the present disclosure.

FIG. 2 shows another exemplary view of the interchangeable door liner system according to an embodiment of the present disclosure.

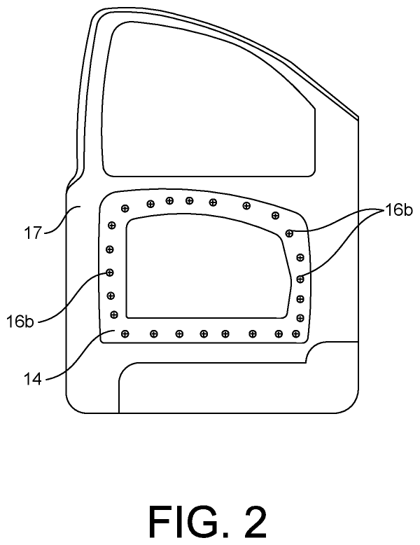

### SUMMARY OF THE INVENTION

Exemplary embodiments disclosed herein describe an interchangeable door liner system including at least one panel cover member, a strip member and a plurality of secondary fastener members. The at least one cover member is configured to attached to an interior door panel of an automobile. The at least one panel cover member has a plurality of primary fastener members integrated therein positioned along an outline of the at least one panel cover member. The strip member is integrated into the interior door panel and forms a frame surrounding an area of the interior door panel where the at least one panel cover member is attached. The strip member includes a plurality of secondary fastener members integrated therein positioned along the strip member in a same position as a corresponding primary fastener member integrated in the at least one panel cover member. Each secondary fastener member and corresponding primary fastener member is configured to attach to one another in a mating connection thereby providing a semi-permanent attachment of the at least one panel cover member to the interior door panel.

In some exemplary embodiments, the system includes an anchor member including a pair of anchor fasteners for stabilizing the attachment of the at least one panel cover member to the interior door panel.

In some exemplary embodiments, the pair of anchor fasteners are heavy-duty snap fasteners.

In some exemplary embodiments, the at least one panel cover member is interchangeable.

In some exemplary embodiments, the at least one panel cover member is removable from the strip member.

In some exemplary embodiments, the at least one panel cover member includes customized imagery thereon.

In some exemplary embodiments, the customized imagery includes one or more from a group comprising images, logos, pictures, themes, colors, words, letters, and decorations.

In some exemplary embodiments, the plurality of primary fastener members include a socket and a cap.

In some exemplary embodiments, the plurality of secondary fastener members include a stud and an eyelet.

### DETAILED DESCRIPTION

The present disclosure relates to an interchangeable door liner system (“the system”). The device includes one or more removable door panel covers that snap on and off of a strip frame built into an interior door panel of an automobile. The removable door panel covers may be customized to showcase a variety of images, logos, themes, pictures, jewel type letters, colors, and various other forms of designs and décor. The system promotes individuality, personality and uniqueness by allowing users to define what image, design, décor or message they desire to display on the one or more removable door panel covers. Moreover, the removable door panel covers may be customized for marketing and advertising purposes.

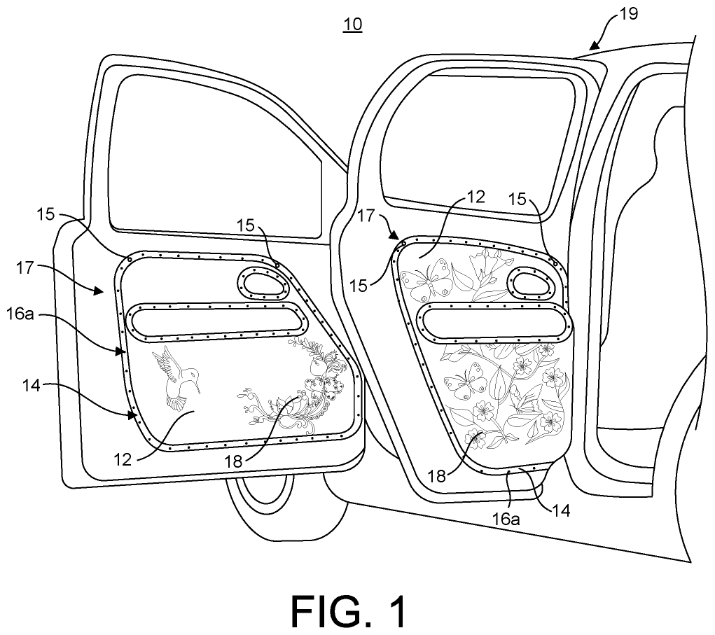

Turning to FIG. 1, the system 10 includes at least one panel cover member 12, a strip member 14, an anchor member 15, a plurality of primary fastener members 16a, and a plurality of secondary fastener members 16b. The at least one panel cover member 12 is configured to attach to an interior door panel 17 of an automobile 19. At setup, the strip member 14 is installed in the interior door panel of the automobile. The strip member 14 may be installed in the interior door panel by loosening the lining of the interior door panel 17 and attaching the strip member to the lining using rivets and then tightening back the lining of the interior door panel. The strip member 14 includes integrated fasteners (i.e., secondary fastener members) 16 that mate with the integrated fasteners (i.e., primary fastener members) 16 included with the panel cover member 12. The at least one panel cover member 12 attaches to the interior door panel 17 by connecting the primary fastener members and the secondary fastener members to one another. The system 10 includes an anchor member 15 to lock-in the connection of the panel cover member 12 to the interior door panel.

Moreover, the at least one panel cover member 12 may be removed from the interior door panel 17 by disconnecting the anchor member 15 and by disconnecting the primary and secondary fastener members 16 from one another. To this point, the panel cover member 12 may be swapped (i.e., interchanged) with a different panel cover member by simply removing the currently attached panel cover member 12 from the interior door panel (i.e., strip member 14) and attaching a different panel cover member to strip member 14.

As shown in FIG. 1, the at least one panel cover member 12 is configured in a shape similar to the outline of the interior door panel 17 including cut outs for parts attached to the interior door, such as, for example, an armrest, etc. The panel cover member 12 includes a plurality of integrated primary fastener members 16 which are positioned along an outline of the panel cover member. As noted, the primary fastener members are configured to connect to the secondary fastener members integrated on strip member 14.

The at least one panel cover member 12 may be made from any suitable material, such as, for example, plastic, cardboard, etc. The panel cover member 12 may be custom made to include a customized/personalized visual imprint 18, such as, for example, images, logos, themes, pictures, messages (i.e., words), colors, decorations, etc. A user may select the visual imprint for showcase on the at least one panel cover member 12 and thereafter the panel cover member is custom made for attachment to the interior door panel as described above. All panel cover members are configured the same (i.e., size and shape) for ease of interchanging one panel cover member for a different panel cover member.

The strip member 14 is integrated into the interior door panel 17 and forms a frame structure for receiving the at least one panel cover member 12. As shown in FIG. 1, the strip member forms a frame surrounding an area of the interior door panel where the panel cover member 12 will be attached. The strip member 14 including a plurality of secondary fastener members 16 integrated therein positioned along the strip member in a same position as a corresponding primary fastener member integrated in the at least one panel cover member. The secondary fastener member and corresponding primary fastener member are configured to attach to one another in a mating connection thereby providing a semi-permanent attachment of the at least one panel cover member to the interior door panel.

The anchor member 15 may include a pair of anchor fasteners for stabilizing the attachment of the at least one panel cover member 12 to the interior door panel. The anchor fasteners may include heavy duty fasteners which are inherently designed to be stable, robust, strong and able to withstand the stresses of demanding use. Any suitable heavy duty fasteners may be used. In a preferred embodiment, the anchor fasteners are heavy duty snap fasteners. The snap fasteners include a top portion and a bottom portion which form a mating connection with one another. The top portion may include a cap and socket which may be attached to the at least one panel cover member 12. The bottom portion may include a stud and eyelet which may be attached to the strip member 14.

The primary fastener members 16a and the secondary fastener members 16b may be any suitable fasteners. In a preferred embodiment, the fastener members 16 are standard snap fasteners. In this embodiment, the primary fastener members include a cap and socket and the secondary fastener members include a stud and eyelet. The cap and socket mates with the stud and eyelet. As such, the primary fastener members and the secondary fastener members attach to one another as a mating connection.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. An interchangeable door liner system comprising:
at least one panel cover member configured to attached to an interior door panel of an automobile, the at least one panel cover member having a plurality of primary fastener members integrated therein positioned along an outline of the at least one panel cover member; and
a strip member integrated into the interior door panel forming a frame surrounding an area of the interior door panel where the at least one panel cover member is attached, the strip member including a plurality of secondary fastener members integrated therein positioned along the strip member in a same position as a corresponding primary fastener member integrated in the at least one panel cover member, wherein each secondary fastener member and corresponding primary fastener member is configured to attach to one another in a mating connection thereby providing a semi-permanent attachment of the at least one panel cover member to the interior door panel.

2. The system of claim 1, further comprising an anchor member including a pair of anchor fasteners for stabilizing the attachment of the at least one panel cover member to the interior door panel.

3. The system of claim 1, wherein the pair of anchor fasteners are heavy-duty snap fasteners.

4. The system of claim 1, wherein the at least one panel cover member is interchangeable.

5. The system of claim 1, wherein the at least one panel cover member is removable from the strip member.

6. The system of claim 1, wherein the at least one panel cover member showcases a customized visual imprint.

7. The system of claim 1, wherein the customized visual imprint includes one or more from a group comprising images, logos, pictures, themes, colors, words, letters, and decorations.

8. The system of claim 1, wherein the plurality of primary fastener members include a cap and are socket.

9. The device of claim 1, wherein the plurality of secondary fastener members include a stud and an eyelet.
